(19) United States
(12) Patent Application Publication
(10) Pub. No.: US 2014/0189766 A1
(43) Pub. Date: Jul. 3, 2014

(54) METHODS AND APPARATUS FOR SEEKING WITHIN RECORDED MEDIA STORED ON A SET-TOP BOX

(71) Applicant: SLING MEDIA INC., Foster City, CA (US)

(72) Inventors: David Eyler, San Francisco, CA (US); Padmanabha R. Rao, Palo Alto, CA (US)

(73) Assignee: SLING MEDIA INC., Foster City, CA (US)

(21) Appl. No.: 13/787,121

(22) Filed: Mar. 6, 2013

Related U.S. Application Data
(60) Provisional application No. 61/746,647, filed on Dec. 28, 2012.

(51) Int. Cl. H04N 9/87

(52) U.S. Cl. CPC H04N 9/87
USPC 725/110; 386/344; 725/153; 386/230

(57) ABSTRACT

A method of viewing recorded media in accordance with one embodiment includes receiving a media stream from a remotely located media source over a network, storing the media stream on a media storage device, and generating a condensed media file to store a subset of frames of the media stream. Further, the method includes receiving a seek request associated with a specified time within the media stream, determining a first frame within the subset of frames in the condensed media file that is previous to and closest in time to the specified time, and displaying the first frame.

### CROSS-REFERENCES TO RELATED APPLICATIONS

This application claims priority to U.S. Provisional Application Ser. No. 61/746,647, filed Dec. 28, 2012.

### TECHNICAL FIELD

The present disclosure generally relates to user interfaces used in connection with recorded media stored on a set-top box, and more particularly relates to methods for seeking within a condensed media stream associated with such recorded media.

### BACKGROUND

Various forms of set-top boxes and related devices are known in the art. Recently, consumers have expressed significant interest in “place shifting” devices that allow viewing of television or other media content at locations other than their primary television set. Place shifting devices typically packetize media content that can be transmitted over a local or wide area network to a portable computer, mobile phone, personal digital assistant, remote television or other remote device capable of playing back the packetized media stream for the viewer. Placeshifting therefore allows consumers to view their media content from remote locations such as other rooms, hotels, offices, and/or any other locations where portable media player devices can gain access to a wireless or other communications network.

In the context of media streaming, including for example conventional general purpose computers running software for streaming place-shifted media, it is desirable to allow a user to seek within the media time buffer to find a particular scene or time slot, and then continue viewing the media from that point. The user interface for such a seeking operation typically allows a user to move (or “scrub”) an icon such as a play-head icon across a visual representation of a timeline associated with the media. In response, the software then goes to the nearest keyframe, decodes and drops all frames until it reaches the desired position (i.e., time), then displays the correct frame.

Place shifting devices and other devices that receive and display content may also be configured with media storage capabilities that allow the user to record and store media that has been streamed to or otherwise received by the device. A common media storage device known in the art is the Digital Video Recorder (DVR), which includes a storage disk coupled with the media reception means that allows for live or streamed television to be recorded for later playback. Conventional DVR systems allow the user to seek through the stored media using a “fast forward” feature, which increases the playback rate of the media to allow the user to more quickly reach a desired point in the recorded media. A “rewind” feature functions similarly, but providing a reverse playback.

Conventional DVRs do not include programming for a media time buffer or for keyframes, as the media has already been recorded and stored. As such conventional “scrub and seek” methods used for streaming media are not able to be employed on DVR devices. As a result, the user has no convenient way to quickly and conveniently search through the media content to find a desired point in time, without waiting for the fast forward or rewind feature to progress/regress the playback.

It is therefore desirable to create systems and methods for seeking in recorded media content, such as content stored on a DVR, in a way that is responsive, intuitive, and provides useful real-time information to the user. These and other desirable features and characteristics will become apparent from the subsequent detailed description and the appended claims, taken in conjunction with the accompanying drawings and this background section.

### BRIEF SUMMARY

According to various exemplary embodiments, systems and methods are described for seeking within stored media, for example on a DVR. A method in accordance with one embodiment includes receiving a media stream from a remotely located media source over a network, storing the media stream on a media storage device, and generating a condensed media file to store a subset of frames of the media stream. Further, the method includes receiving a seek request associated with a specified time within the media stream, determining a first frame within the subset of frames in the condensed media file that is previous to and closest in time to the specified time, and displaying the first frame.

In another exemplary embodiment, a set-top box includes a communication interface configured to receive a media stream from a remotely located media source over a network, a media storage device configured to store the media stream on a media storage device, a control logic configured to generate a condensed media file to store a subset of frames of the media stream, and an input interface configured to receive a seek request associated with a specified time within the media stream. The control logic is further configured to determine a first frame within the subset of frames in the condensed media file that is previous to and closest in time to the specified time and display the first frame.

In yet another exemplary embodiment, a system includes a user input device, a display device, and a media receiving device operably coupled with the display device. The media receiving device includes a communication interface configured to receive a media stream from a remotely located media source over a network, a media storage device configured to store the media stream on a media storage device, a control logic configured to generate a condensed media file to store a subset of frames of the media stream, and an input interface configured to receive a seek request from the user input device that is associated with a specified time within the media stream. The control logic is further configured to determine a first frame within the subset of frames in the condensed media file that is previous to and closest in time to the specified time and display the first frame on the display device.

### BRIEF DESCRIPTION OF THE DRAWING FIGURES

Exemplary embodiments will hereinafter be described in conjunction with the following drawing figures, wherein like numerals denote like elements, and

FIG. 1 is a block diagram of an exemplary media encoding system;

FIG. 2 is a block diagram of an exemplary media encoding device;

FIG. 3 illustrates an embodiment of an electronic programming guide outputted by a DVR;

FIG. 4 is a conceptual overview of a typical time line user interface used in connection with a condensed image stream; and

FIG. 5 is a flowchart depicting a method in accordance with an exemplary embodiment;

FIG. 6 depicts, conceptually, a buffer seek process in accordance with the present invention.

### DETAILED DESCRIPTION

The following detailed description of the invention is merely exemplary in nature and is not intended to limit the invention or the application and uses of the invention. Furthermore, there is no intention to be bound by any theory presented in the preceding background or the following detailed description.

The embodiments presented herein provide media storage devices enabled with an improved seeking functionality. While the particular embodiments set forth herein are described in the context of a placeshifting encoder system, it will be appreciated that the teachings herein will be applicable to any device configured to receive and store media content, including but not limited to conventional set-top boxes for receiving media content from satellite, cable, internet, or over-the-air media sources.

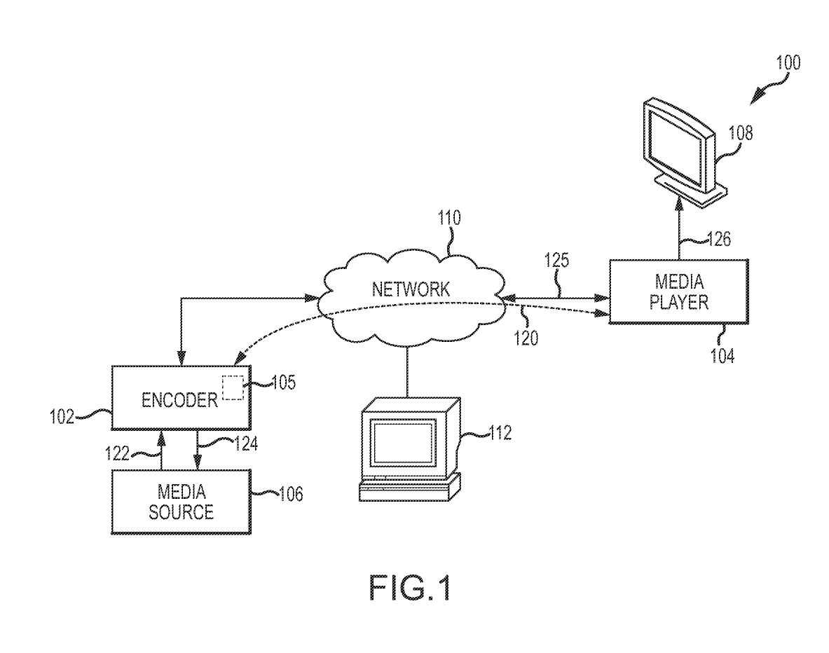

Turning now to the drawing figures and with initial reference to FIG. 1, an exemplary placeshifting system 100 suitably includes a placeshifting encoder system 102 that receives media content 122 from a content source 106, encodes the received content into a streaming format, and then transmits the encoded media stream 120 to a media player 104 over network 110. The media player 104 suitably receives the encoded stream 120, decodes the stream, and presents the decoded content to a viewer on a television or other display 108. In various embodiments, a server 112 may also be provided to communicate with encoder system 102 and/or player 104 via network 110 to assist these devices in locating each other, maintaining security, providing or receiving content or information, and/or any other features as desired. This feature is not required in all embodiments, however, and the concepts described herein may be deployed in any data streaming application or environment, including placeshifting but also any other media or other data streaming situation.

Placeshifting encoder system 102 is any component, hardware, software logic and/or the like capable of transmitting a packetized stream of media content over network 110. In various embodiments, placeshifting device 102 incorporates suitable encoder and/or transcoder (collectively “encoder”) logic to convert audio/video or other media data 122 into a packetized format that can be transmitted over network 110. The media data 122 may be received in any format, and may be received from any internal or external source 106 such as any sort of broadcast, cable or satellite television programming source, a “video-on-demand” or similar source, a digital video disk (DVD) or other removable media, a video camera, and/or the like. Encoder system 102 encodes media data 122 to create media stream 120 in any manner. In various embodiments, encoder system 102 contains a transmit buffer 105 that temporarily stores encoded data prior to transmission on network 110. As buffer 105 fills or empties, one or more parameters of the encoding (e.g., the bit rate of media stream 120) may be adjusted to maintain desirable picture quality and data throughput in view of the then-current network performance. Changes in the network transfer rate may be identified from, for example, changes in the utilization of the outgoing buffer 105.

Several examples of encoding systems 102 may be implemented using any of the various SLINGBOX® products available from Sling Media, Inc. of Foster City, Calif., although other products could be used in other embodiments. Many different types of encoder systems 102 are generally capable of receiving media content 122 from an external source 106 such as any sort of digital video recorder (DVR), set top box (STB), cable or satellite programming source, DVD player, and/or the like. In such embodiments, encoder system 102 may additionally provide commands 124 to the source 106 to produce desired signals 122. Such commands 124 may be provided over any sort of wired or wireless interface, such as an infrared or other wireless transmitter that emulates remote control commands receivable by the source 106. Other embodiments, however, particularly those that do not involve placeshifting, may modify or omit this feature entirely.

In other embodiments, encoder system 102 may be integrated with any sort of content receiving or other capabilities typically affiliated with source 106. Encoder system 102 may be a hybrid STB or other receiver, for example, that also provides transcoding and placeshifting features. Such a device may receive satellite, cable, broadcast and/or other signals that encode television programming or other content received from an antenna, modem, server and/or other source. The receiver may further demodulate or otherwise decode the received signals to extract programming that can be locally viewed and/or place shifted to a remote player 104 as appropriate. Such devices 102 may also include a content database stored on a hard disk drive, memory, or other storage medium to support a personal or digital video recorder (DVR) feature or other content library as appropriate. Hence, in some embodiments, source 106 and encoder system 102 may be physically and/or logically contained within a common component, housing or chassis.

In still other embodiments, encoder system 102 is a software program, applet or the like executing on a conventional computing system (e.g., a personal computer). In such embodiments, encoder system 102 may encode, for example, some or all of a screen display typically provided to a user of the computing system for placeshifting to a remote location. One device capable of providing such functionality is the SlingProjector® product available from Sling Media, Inc. of Foster City, Calif., which executes on a conventional personal computer, although other products could be used as well.

Media player 104 is any device, component, module, hardware, software and/or the like capable of receiving a media stream 120 from one or more encoder systems 102. In various embodiments, remote player 104 is personal computer (e.g., a “laptop” or similarly portable computer, although desktop-type computers could also be used), a mobile phone, a personal digital assistant, a personal media player (such as the ARCHOS products available from the Archos company of Igny, France) or the like. In many embodiments, remote player 104 is a general purpose computing device that includes a media player application in software or firmware that is capable of securely connecting to placeshifting encoder system 102, as described more fully below, and of receiving and presenting media content to the user of the device as appropriate. In other embodiments, however, media player 104 is a standalone or other separate hardware device capable of receiving the media stream 120 via any portion of network 110 and decoding the media stream 120 to provide an output signal 126 that is presented on a television or other display 108. One example of a standalone media receiver 104 is the SLINGCATCHER® product available from Sling Media, Inc. of Foster City, Calif., although other products could be equivalently used.

Network 110 is any digital or other communications network capable of transmitting messages between senders (e.g., encoder system 102) and receivers (e.g., receiver 104). In various embodiments, network 110 includes any number of public or private data connections, links or networks supporting any number of communications protocols. Network 110 may include the Internet, for example, or any other network based upon TCP/IP or other conventional protocols. In various embodiments, network 110 also incorporates a wireless and/or wired telephone network, such as a cellular communications network for communicating with mobile phones, personal digital assistants, and/or the like. Network 110 may also incorporate any sort of wireless or wired local area networks, such as one or more IEEE 802.3 and/or IEEE 802.11 networks.

Encoder system 102 and/or player 104 are therefore able to communicate with player 104 in any manner (e.g., using any sort of data connections 128 and/or 125, respectively). Such communication may take place over a wide area link that includes the Internet and/or a telephone network, for example; in other embodiments, communications between devices 102 and 104 may take place over one or more wired or wireless local area links that are conceptually incorporated within network 110. In various equivalent embodiments, encoder system 102 and receiver 104 may be directly connected via any sort of cable (e.g., an Ethernet cable or the like) with little or no other network functionality provided.

Many different placeshifting scenarios could be formulated based upon available computing and communications resources, consumer demand and/or any other factors. In various embodiments, consumers may wish to placeshift content within a home, office or other structure, such as from a placeshifting encoder system 102 to a desktop or portable computer located in another room. In such embodiments, the content stream will typically be provided over a wired or wireless local area network operating within the structure. In other embodiments, consumers may wish to placeshift content over a broadband or similar network connection from a primary location to a computer or other remote player 104 located in a second home, office, hotel or other remote location. In still other embodiments, consumers may wish to placeshift content to a mobile phone, personal digital assistant, media player, video game player, automotive or other vehicle media player, and/or other device via a mobile link (e.g., a GSM/EDGE or CDMA/EVDO connection, any sort of 3G or subsequent telephone link, an IEEE 802.11 “Wi-fi” link, and/or the like). Several examples of placeshifting applications available for various platforms are provided by Sling Media, Inc. of Foster City, Calif., although the concepts described herein could be used in conjunction with products and services available from any source.

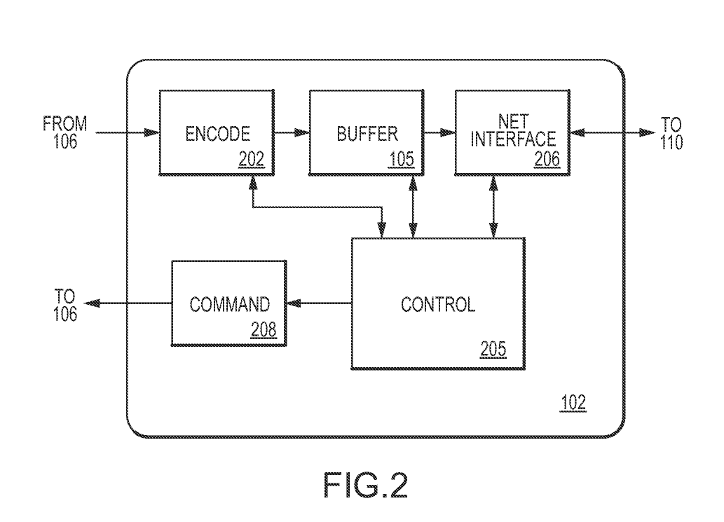

Encoder system 102, then, generally creates a media stream 120 that is routable on network 110 based upon content 122 received from media source 106. To that end, and with reference now to FIG. 2, encoder system 102 typically includes an encoder module 202, a buffer 105 and a network interface 206 in conjunction with appropriate control logic 205. In operation, encoder module 202 typically receives media content 122 from an internal or external source 106, encodes the data into the desired format for media stream 120, and stores the encoded data in buffer 105. Network interface 206 then retrieves the formatted data from buffer 105 for transmission on network 110. Control module 205 suitably monitors and controls the encoding and network transmit processes carried out by encoding module 202 and network interface 206, respectively, and may perform other features as well. Encoder system 102 may also have a module 208 or other feature capable of generating and providing commands 124 to an external media source 106, as described above.

In the exemplary embodiment shown in FIG. 2, modules 202, 105, 205, 206 and 208 may be implemented in software or firmware residing in any memory, mass storage or other storage medium within encoder system 102 in source code, object code and/or any other format. Such features may be executed on any sort of processor or microcontroller executing within encoder system 102. In various embodiments, encoder system 102 is implemented as a system on a chip (SoC) type system with integrated processing, storage and input/output features. Various SoC hardware implementations are available from Texas Instruments, Conexant Systems, Broadcom Inc., and other suppliers as appropriate. Other embodiments may use any number of discrete and/or integrated processing components, memories, input/output features and/or other features as desired.

As noted above, creating a media stream 120 typically involves encoding and/or transcoding an input media stream 122 received from an internal or external media source 106 into a suitable digital format that can be transmitted on network 110. Generally, the media stream 120 is placed into a standard or other known format (e.g., the WINDOWS MEDIA format available from the Microsoft Corporation of Redmond, Wash. although other formats such as the QUICKTIME format, REALPLAYER format, MPEG format, and/or the like could be used in any other embodiments) that can be transmitted on network 110. This encoding may take place, for example, in any sort of encoding module 202 as appropriate. Encoding module 202 may be any sort of hardware (e.g., a digital signal processor or other integrated circuit used for media encoding), software (e.g., software or firmware programming used for media encoding that executes on the SoC or other processor described above), or the like. Encoding module 202 is therefore any feature that receives media data 122 from the internal or external source 106 (e.g., via any sort of hardware and/or software interface) and encodes or transcodes the received data into the desired format for transmission on network 110. Although FIG. 2 shows a single encoding module 202, in practice system 102 may include any number of encoding modules 202. Different encoding modules 202 may be selected based upon preference of player 104, network conditions, and/or the like.

In various embodiments, encoder 202 may also apply other modifications, transforms and/or fillers to the received content before or during the transcoding process. Video signals, for example, may be resized, cropped and/or skewed. Similarly, the color, hue and/or saturation of the signal may be altered, and/or noise reduction or other filtering may be applied. Audio signals may be modified by adjusting volume, sampling rate, mono/stereo parameters, noise reduction, multi-channel sound parameters and/or the like. Digital rights management encoding and/or decoding may also be applied in some embodiments, and/or other features may be applied as desired.

As initially noted above, system 102 may also include a content database stored on a hard disk drive, memory, or other storage medium to support a personal or digital video recorder (DVR) feature or other content library as appropriate. For example, the media that is streamed to, and received by system 102, as an alternative to (or in addition to) being displayed in real-time on the display device 108, may be recorded and stored on the storage media, such as a DVR, for later playback and viewing.

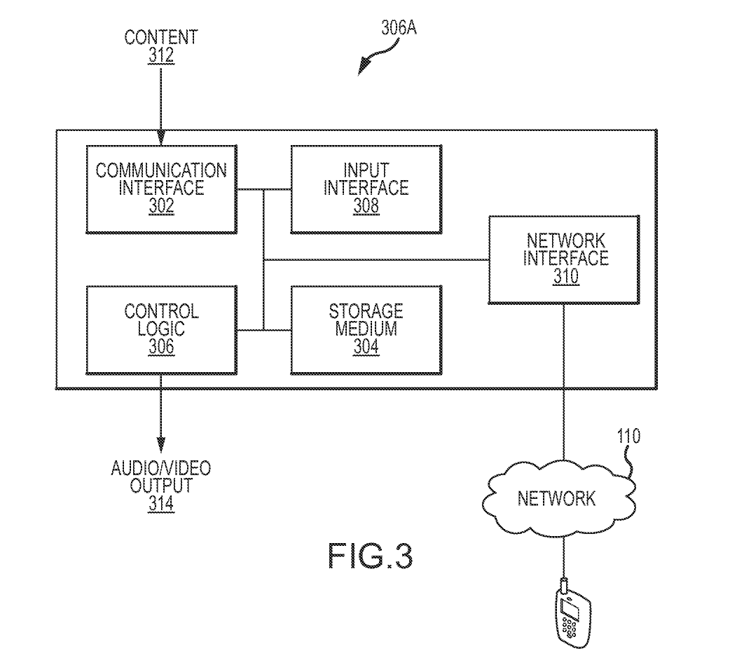

Greater detail regarding an exemplary DVR feature that may be included with the placeshifting media system 102 is now provided, with reference to FIG. 3. FIG. 3 illustrates an embodiment of a DVR 306A. FIG. 3 will be discussed in reference to the communication network 110 illustrated in FIG. 1. The DVR 306A includes a communication interface 302, a storage medium 304, control logic 306, an input interface 308, and a network interface 310. The DVR 306A may also include other elements, components or devices.

The communication interface 302 is operable to receive content 312 from the system 102. More particularly, the communication interface 302 may receive media content 312 including television programming. In an embodiment, the communication interface 302 may receive place-shifted media content 312 as described in greater detail above. In other embodiments, the communication interface 302 may further be configure to receive an over-the-air (OTA) broadcast, a direct broadcast satellite signal, a cable television signal or an internet protocol television (IPTV) signal and tune the content 312 to extract the selected television programming. The communication interface 302 may comprise multiple media input interfaces and/or multiple tuners, utilized by the DVR 306A to receive and/or record multiple television programs simultaneously, such as may be provided thereto by the exemplary place-shifting system 102 described above with regard to FIG. 1. The storage medium 304 is operable to persistently store video signals recorded by the DVR 306A. The storage medium 304 may also store other data, such as metadata associated with the recorded video signals. The storage medium 304 may comprise any type of non-volatile memory appropriate for storing video signals recorded by the DVR 306A. Exemplary storage mediums 304 include hard drives (e.g., magnetic memory), flash memory, battery backed up memory and the like. The storage medium 304 may be internally located within the DVR 306A. Alternatively, the storage medium 304 may be located external to the DVR 306A. The DVR 306A may also utilize a combination of internal and external storage mediums 304 for storage of video signals.

The input interface 308 is operable to wirelessly receive data from a remote control. The input interface 308 may communicate with a remote control utilizing any type of IR or RF communication link. The input interface 308 may receive a key code from a remote control and responsively provide the key code to the control logic 306 for processing. The data received from the remote control may be utilized by the control logic 306 to control the output of content by the control logic 306. The input interface 308 may also receive data from other devices besides the remote control, such as a mobile telephone, personal digital assistant, smartphone, tablet computer, or the like. For example, a mobile telephone, personal digital assistant, smartphone, tablet computer, or the like may include an application allowing the mobile telephone to remotely control the DVR 106 similarly to the remote control.

The control logic 306 is operable to control the operation of the DVR 306A. The control logic 306 may be a single processing device or a plurality of processing devices that cooperatively operate to control the operation of the DVR 306A. The control logic 306 may include various components or modules for processing and outputting audio/video content. Exemplary components or modules for processing audio/video content include a demodulator, a decoder, a decompressor, a conditional access module and a transcoder module. The control logic 306 coordinates storage of the content 212 onto the storage medium 304. More particularly, the control logic 306 operates responsive to recording timers configured on the DVR 306A to command the communication interface 302 to receive content from a specified channel and coordinates storage of the content onto the storage medium 304.

In an embodiment, the control logic 306 is operable to generate an audio/video output 314 based on the content 312, e.g., pass through the signal for display by an associated presentation device. The control logic 306 is also operable to retrieve stored video content from the storage medium 304 to generate an audio/video output 314 for display by the presentation device. The presentation device then presents the audio/video output 314 to the user. The control logic 306 may incorporate circuitry to output the audio/video streams in any format recognizable by the presentation device 108, including composite video, component video, Digital Visual Interface (DVI), High-Definition Multimedia Interface (HDMI), 1394 and WiFi (e.g., streaming digital video over an internet connection). The control logic 306 may also incorporate circuitry to support multiple types of these or other audio/video formats. In an embodiment, the DVR 306A may be integrated with the presentation device 108, and the control logic 306 may be operable to control the presentation of the audio/video output 314 by the presentation device.

To coordinate the storage of the content 312, the control logic 306 is operable to receive user input requesting to record one or more television programs or other media content. For example, the user may utilize the remote control to select a program for recording that may be received by the exemplary media place-shifting system 102 as described in greater detail above. Responsive to the user input requesting to record the program, the control logic 306 identifies an originator of the recording request. For example, a user may provide identifying information in association with the request.

In various embodiments, including those in which media is streamed (or otherwise broadcast) to a media player 104 that comprises a general purpose computer running a media application, DVR 306A produces and stores a condensed media file of the streamed media content received over network 110 and stored in the storage medium 304. A separate condensed media file may be produced for each individual media content, i.e. media program, received and stored in DVR 306A. The control logic 306 includes a seek module (comprising any combination of hardware and software) that allows a user to search within the condensed media file to find a particular scene or time and then continue viewing the media from that point. As used herein, the term condensed media file includes a subset of the image frames received and stored on DVR 306A for a particular media program or other particular media content. For example, the condensed media file can include every 5^{th} frame of the original media stream, every 10^{th} frame, every 20^{th} frame, every 50^{th} frame, every hundredth frame, or any other subset of image frames of the original media stream as may be desired to produce the condensed media file.

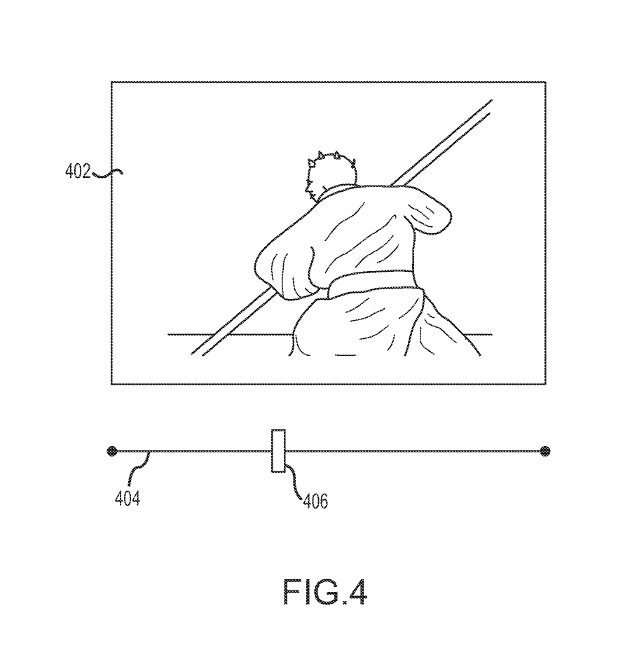

In this regard, FIG. 4 shows a simplified view of a typical user interface used to seek within a condensed media file. In general, a timeline 404 is presented to the user, via audio/video output 314 from control logic 306, such that its geometry corresponds to the extent of the media being viewed, while the condensed media file will typically include a subset of the total media that will ultimately be available for viewing.

In this embodiment, for example, timeline 404 is literally a line segment whose endpoints correspond to the beginning and end of the media. To visualize the current location within the file, an icon 406 (e.g., a rectangular icon as shown) is displayed along timeline 404 at the location that proportionally corresponds to the position of viewed media within window 402. By moving icon 406 back and forth along timeline 404 (to the extent allowed by the recorded information, the user is able to select a particular scene or time within the condensed media file and begin watching the displayed media 302 at that point). It will be appreciated that the various geometries and iconography illustrated in FIG. 4 are merely presented as an example, and that timeline 404, icon 406, and viewed media window 402 may be provided to the user in any number of alternate configurations and may include any number of additional user interface elements.

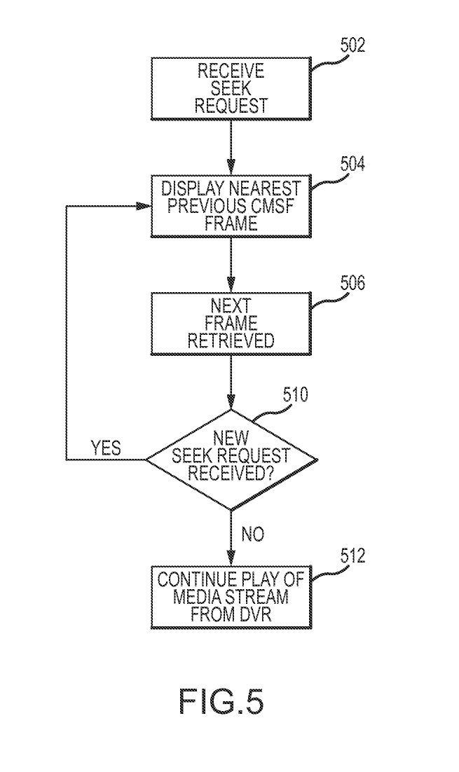

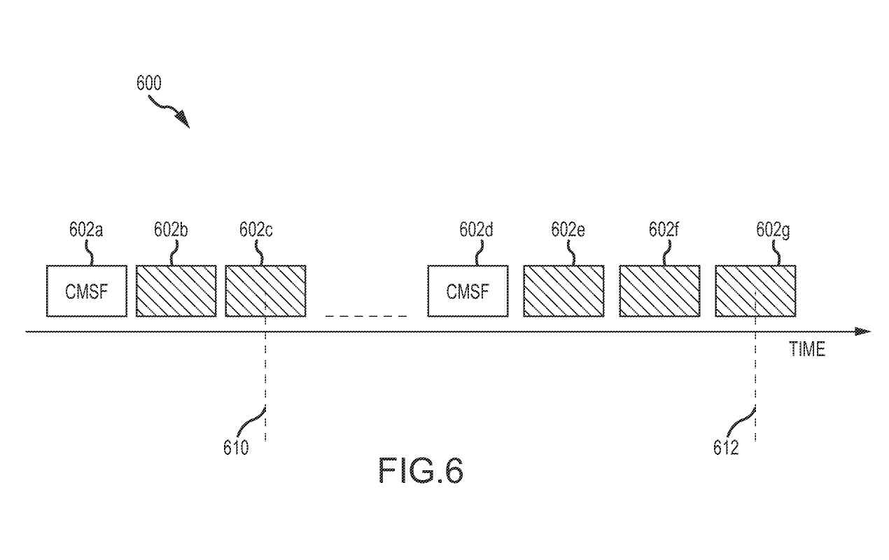

Referring now to FIGS. 5 and 6, an exemplary “seek” method in accordance with one embodiment of the present invention will now be described. The various steps may be implemented in any combination of hardware and software (collectively referred to as the “system”) within media player 104 (FIG. 1).

First, in step 502, the system receives a seek request. This request may take the form of an interrupt or other software message produced, for example, via the user interface of the DVR 306A shown in FIG. 3. In general, the request will include an indication of a desired time within the condensed media file.

That is, referring to FIG. 6, a media stream 600 conceptually includes a set of time-sequential frames 602 (602a, 602b, etc.), of which a subset thereof are used to produce the aforementioned condensed media file (i.e., condensed media file frames, indicated in FIG. 6 as “CMSF”), upon which the seek operation is performed. A typical seek request then might include a request to view the media starting from a time at marker 612.

Accordingly, in step 504, the system displays the nearest previous image of the condensed image stream (e.g., within the displayed media window 402 of FIG. 4). In the current example, the nearest image of the condensed media file corresponds to image frame 602d.

Next, a series of steps are performed in a manner that is cancellable by the receipt of a new seek request or interrupt (e.g., a software or hardware interrupt), thereby decoupling the display of the image of the condensed media file from the consideration of subsequent frames. In step 506, the next frame is retrieved from storage on the DVR 306A. The next frame may correspond to the time marker 612, i.e., the desired location within the media stream sought by the user (frame 502d of the condensed media file subset of frames being presented to the user until the next frame is able to be retrieved from the DVR memory).

Next, in step 510, the system checks whether a new seek request has been made by the user (e.g., using the interface depicted in FIG. 4). This may also be implemented as an interrupt, as is known in the art. If a new seek request has been made (“yes” branch from block 510), the system returns to step 504 and displays the nearest image from the condensed media file, then continues as before, effectively cancelling the previous retrieval operation.

That is, if the user requests to view the buffer at time marker 610, the previous retrieval operation would be cancelled, and the system would display the condensed media file frame 602a in place of previously displayed frame 602d. Otherwise, at step 512, the media continues to play from the next frame (i.e., 602g) and thence forth.

It will be apparent that the nature of the display of frames from the condensed media file and subsequent searching through the condensed media file in the described “scrub and seek” methodology is highly advantageous from a user interface standpoint. The user is presented with real-time visual feedback that is responsive to his input from the condensed media file, which is readily available, while the DVR retrieves the next frame of the condensed media file corresponding to the time marker. In this manner, the user is provided with visual cues that roughly correspond to the time marker as the user “scrubs and seeks” across the time bar as shown in FIG. 6, thereby enabling the user to enjoy a quicker and more informative searching process.

Control and manipulation of the icon 404, in one embodiment, is provided by a user input device, such as a remote control device operably coupled with the media player 104. Broadly, as used herein, a user input device may comprise a remote control, a keyboard, a digital video camera, a digital microphone, or other peripheral device for providing input to media player 104. It is to be understood that multiple user input devices may be configured to communicate, either wirelessly or with a wired connection, to the entertainment device. Some input devices may combine the functionality of several different user input devices. In at least one embodiment, a user input device comprises a cell phone, smart phone, PDA, tablet, or other mobile computing device that is configured to communicate via a wired or wireless communication session with the entertainment device, via any of various communications protocols and/or technologies that are known in the art (e.g., TCP/IP, Bluetooth, etc.).

The term “exemplary” is used herein to represent one example, instance or illustration that may have any number of alternates. Any implementation described herein as exemplary is not necessarily to be construed as preferred or advantageous over other implementations. While several exemplary embodiments have been presented in the foregoing detailed description, it should be appreciated that a vast number of alternate but equivalent variations exist, and the examples presented herein are not intended to limit the scope, applicability, or configuration of the invention in any way. To the contrary, various changes may be made in the function and arrangement of elements described without departing from the scope of the claims and their legal equivalents.

What is claimed is:

1. A method of viewing recorded media, the method comprising the steps of:
receiving a media stream from a remotely located media source over a network;
storing the media stream on a media storage device;
generating a condensed media file to store a subset of frames of the media stream;
receiving a seek request associated with a specified time within the media stream;
determining a first frame within the subset of frames in the condensed media file that is previous to and closest in time to the specified time; and
displaying the first frame.

2. The method of claim 1, wherein receiving the media steam over the network comprises receiving the media stream over the internet.

3. The method of claim 1, wherein storing the media stream on a media storage device comprises storing the media stream on a placeshifting device.

4. The method of claim 3, wherein the storing the media stream on the placeshifting device comprises storing the media stream on a digital video recorder associated with the placeshifting device.

5. The method of claim 1, wherein generating the condensed media file comprises storing every n^{th} frame of the media stream.

6. The method of claim 1, further comprising displaying the stored media stream beginning from the first frame.

7. The method of claim 1, wherein receiving a seek request comprises receiving an input from a user input device indicating a manipulation of a seek icon.

8. A set-top box comprising:
a communication interface configured to receive a media stream from a remotely located media source over a network;
a media storage device configured to store the media stream on a media storage device;
a control logic configured to generate a condensed media file to store a subset of frames of the media stream; and
an input interface configured to receive a seek request associated with a specified time within the media stream;
wherein the control logic is further configured to determine a first frame within the subset of frames in the condensed media file that is previous to and closest in time to the specified time and display the first frame.

9. The set-top box of claim 8, wherein the media storage device is a digital video recorder (DVR).

10. The set-top box of claim 8, wherein the set-top box is configured as a placeshifting device, and wherein the communication interface is configured to receive the media stream over the internet.

11. The set-top box of claim 8, wherein the control logic is configured to generate a condensed media file that stores every n^{th} frame of the media stream.

12. The set-top box of claim 8, wherein the control logic is configured to display the stored media stream beginning from the first frame.

13. The set-top box of claim 8, wherein the input interface is configured to receive a seek request that comprises an input from a user input device indicating a manipulation of a seek icon.

14. The set-top box of claim 13, wherein the manipulation of the seek icon comprises a directional movement of the seek icon along a timeline bar.

15. A system comprising:
a user input device;
a display device; and
a media receiving device operably coupled with the display device and comprising:
a communication interface configured to receive a media stream from a remotely located media source over a network;
a media storage device configured to store the media stream on a media storage device;
a control logic configured to generate a condensed media file to store a subset of frames of the media stream; and
an input interface configured to receive a seek request from the user input device that is associated with a specified time within the media stream;
wherein the control logic is further configured to determine a first frame within the subset of frames in the condensed media file that is previous to and closest in time to the specified time and display the first frame on the display device.

16. The system of claim 15, wherein the network is a satellite broadcast network.

17. The system of claim 15, wherein the network is a cable broadcast network.

18. The system of claim 15, wherein the network is an over-the-air broadcast network.

19. The system of claim 15, wherein the user input device is a remote control device.

20. The system of claim 15, wherein the user input device is a cell phone, smart phone, or tablet device.
